(19) United States
(12) Patent Application Publication
(10) Pub. No.: US 2024/0242615 A1
(43) Pub. Date: Jul. 18, 2024

(54) OVERLAYING FLIGHT PATHS FOR ENVIRONMENTAL IMPACT MITIGATION

(71) Applicant: THE BOEING COMPANY, Arlington, VA (US)

(72) Inventors: Kirk A. VINING, Renton, WA (US); Alvin L. SIPE, Kenmore, WA (US); Stephen S. ALTUS, Campbell, CA (US); Steven L. BAUGHCUM, Redmond, WA (US); Tristan C. FLANZER, Seattle, WA (US)

(21) Appl. No.: 18/154,657

(22) Filed: Jan. 13, 2023

(51) Int. Cl. G08G 5/00

(52) U.S. Cl. CPC G08G 5/0039

(57) ABSTRACT

The present disclosure provides for identifying common flight path portions for aircraft and determining, from various factors and variables, an improved flight plan to take advantage of improved environmental impact mitigation for aircraft flying through a same or similar area. These improved flight plans reduce environmental impacts of the aircraft without greatly increasing wear on the aircraft, which can reduce an environmental impact of an aircraft fleet and a general aircraft flight network.

### FIELD

Aspects of the present disclosure relate to aircraft control. More particularly, the present disclosure provides systems and methods for using aircraft routing to provide for overlaying aircraft flight routes to reduce environmental impacts of aircraft in flight.

### BACKGROUND

Aircraft in flight produce several types of environmental impacts, including emissions from fuel consumption and noise emissions from aircraft traveling through airspace. Another common environmental impact of aircraft in flight is the formation of vapor or condensation trails which are commonly referred to as contrails. Contrails form at various altitudes in the atmosphere under various environmental conditions. The fuel and noise emissions can cause alterations in an overall environment including changes in the compensation of the atmosphere as well as discomfort for those who may interact with the noise emissions. Additionally, increasing amounts of research indicate that contrails from aviation may cause changes in heat retention in the surrounding environment. For example, contrails may trap thermal infrared radiation in the atmosphere of the earth. As more and more aircraft are in flight in a given airspace the impact of these emissions and contrails can alter or affect the environment of the airspace and the global environment.

Solutions to continue reducing the environmental impacts caused by the aviation industry, including providing overlay flight routing remains a challenge. For example, the large scale nature of civil and commercial flight operations has prevented aircraft operators, such as commercial airlines, from taking advantage of overlay flight routing to reduce environmental impacts of aircraft fleets.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method including: detecting, based on environmental conditions in an overlay region, conditions for overlay flight routing, identifying, using the environmental conditions and a first route for a first aircraft, an overlay area, and identifying, from the overlay area and a plurality of routes for a plurality of aircraft, a common flight path portion which may include the overlay area and a second route from the plurality of routes for a second aircraft of the plurality of aircraft. The method also includes identifying at least one change to a base flight plan for the second aircraft to provide a rendezvous for the second aircraft to fly within the overlay area over the common flight path portion, generating a plurality of updated flight plans with one or more of the at least one change to the base flight plan for the second aircraft, and selecting, from the plurality of updated flight plans, an improved flight plan for providing overlay objectives in the overlay area. The method also includes replacing the base flight plan for the second aircraft with the improved flight plan, and implementing the improved flight plan for providing overlay objectives in the overlay area for the second aircraft. Other embodiments of this aspect include corresponding computer systems, apparatus, and computer programs recorded on one or more computer storage devices, each configured to perform the actions of the methods.

In one aspect, in combination with any example method above or below, the method where the overlay area may include a contrail mitigation area, and where the overlay objectives may include one or more of: overlaying a contrail produced by the second aircraft in the overlay area with a contrail produced by the first aircraft, disrupting the contrail produced by the first aircraft, and minimizing the contrail produced by the second aircraft based on a lower ambient moisture content due to a formation of the contrail produce by the first aircraft.

In one aspect, in combination with any example method above or below, identifying the overlay area may include: identifying the first aircraft from the plurality of aircraft based on the environmental conditions and a location of the first aircraft at a first time relative to an overlay region, identifying a contrail path produced by the first aircraft traveling through the overlay region, and identifying the overlay area relative to the contrail path produced by the first aircraft, where a following aircraft traveling through the overlay area alters at least one of the contrail path produced by the first aircraft and a contrail path produced by the following aircraft.

In one aspect, in combination with any example method above or below, where identifying the at least one change to the base flight plan for the second aircraft may include determining one or more updated airspeeds for the second aircraft to position the second aircraft within the overlay area, and selecting the improved flight plan may include selecting a rendezvous airspeed based on route control limits for the second aircraft and the plurality of aircraft, where the rendezvous airspeed positions the second aircraft in the overlay area in the common flight path portion.

In one aspect, in combination with any example method above or below, where generating the plurality of updated flight plans may include: generating a plurality of prospective flight plans for routing the second aircraft through the overlay area, and determining a route alteration value for each of the plurality of prospective flight plans, where the updated flight plans may include prospective flight plans with a route alteration value less than a route alteration limit. The route alteration value may include one or more of: an additional fuel burn caused by a prospective flight plan of the plurality of prospective flight plans, additional emissions caused by the prospective flight plan, a delay caused by the prospective flight plan, and additional wear to the second aircraft caused by the prospective flight plan.

In one aspect, in combination with any example method above or below, where the method may include: providing the improved flight plan to a flight plan arbiter for approval, and receiving an approval to implement the improved flight plan at the second aircraft. Implementations of the described techniques may include hardware, a method or process, or computer software on a computer-accessible medium.

The present disclosure provides a system in one aspect. The system includes a processor, a memory storage device including instructions that when executed by the processor perform an operation. The operation may include: detecting, based on environmental conditions in an overlay region, conditions for overlay flight routing, identifying, using the environmental conditions and a first route for a first aircraft, an overlay area, and identifying, from the overlay area and a plurality of routes for a plurality of aircraft, a common flight path portion may include the overlay area and a second route from the plurality of routes for a second aircraft of the plurality of aircraft.

The operation may also include identifying at least one change to a base flight plan for the second aircraft to provide a rendezvous for the second aircraft to fly within the overlay area over the common flight path portion, generating a plurality of updated flight plans with one or more of the at least one change to the base flight plan for the second aircraft, and selecting, from the plurality of updated flight plans, an improved flight plan for providing overlay objectives in the overlay area. The operation also include replacing the base flight plan for the second aircraft with the improved flight plan and implementing the improved flight plan for providing overlay objectives in the overlay area for the second aircraft.

In one aspect, in combination with any example system above or below, the system where the overlay area may include a contrail mitigation area, and where the overlay objectives may include one or more of: overlaying a contrail produced by the second aircraft in the overlay area with a contrail produced by the first aircraft, disrupting the contrail produced by the first aircraft, and minimizing the contrail produced by the second aircraft based on a lower ambient moisture content due to a formation of the contrail produce by the first aircraft.

In one aspect, in combination with any example system above or below, the system where identifying the overlay area may include: identifying the first aircraft from the plurality of aircraft based on the environmental conditions and a location of the first aircraft at a first time relative to an overlay region, identifying a contrail path produced by the first aircraft traveling through the overlay region, and identifying the overlay area relative to the contrail path produced by the first aircraft, where a following aircraft traveling through the overlay area alters at least one of the contrail path produced by the first aircraft and a contrail path produced by the following aircraft.

In one aspect, in combination with any example system above or below, identifying the at least one change to the base flight plan for the second aircraft may include: determining one or more updated airspeeds for the second aircraft to position the second aircraft within the overlay area, and selecting the improved flight plan may include selecting a rendezvous airspeed based on route control limits for the second aircraft and the plurality of aircraft, where the rendezvous airspeed positions the second aircraft in the overlay area in the common flight path portion.

In one aspect, in combination with any example system above or below, the system where Generating the plurality of updated flight plans may include: generating a plurality of prospective flight plans for routing the second aircraft through the overlay area, and determining a route alteration value for each of the plurality of prospective flight plans, where the updated flight plans may include prospective flight plans with a route alteration value less than a route alteration limit. The route alteration value may include one or more of: an additional fuel burn caused by a prospective flight plan of the plurality of prospective flight plans, additional emissions caused by the prospective flight plan, a delay caused by the prospective flight plan, and additional wear to the second aircraft caused by the prospective flight plan.

In one aspect, in combination with any example system above or below, the operation of the system may include: providing the improved flight plan to a flight plan arbiter for approval, and receiving an approval to implement the improved flight plan at the second aircraft.

The present disclosure provides a computer program product in one aspect, the computer program product including a computer-readable storage medium having computer-readable program code embodied therewith, the computer-readable program code executable by one or more computer processors to perform an operation. The operation may include: detecting, based on environmental conditions in an overlay region, conditions for overlay flight routing, identifying, using the environmental conditions and a first route for a first aircraft, an overlay area, identifying, from the overlay area and a plurality of routes for a plurality of aircraft, a common flight path portion may include the overlay area and a second route from the plurality of routes for a second aircraft of the plurality of aircraft, and identifying at least one change to a base flight plan for the second aircraft to provide a rendezvous for the second aircraft to fly within the overlay area over the common flight path portion. The operation also includes generating a plurality of updated flight plans with one or more of the at least one change to the base flight plan for the second aircraft, selecting, from the plurality of updated flight plans, an improved flight plan for providing overlay objectives in the overlay area, and replacing the base flight plan for the second aircraft with the improved flight plan. The operation may also include implementing the improved flight plan for providing overlay objectives in the overlay area for the second aircraft.

In one aspect, in combination with any example computer program product above or below, where the overlay area may include a contrail mitigation area, and where the overlay objectives may include one or more of: overlaying a contrail produced by the second aircraft in the overlay area with a contrail produced by the first aircraft, disrupting the contrail produced by the first aircraft, and minimizing the contrail produced by the second aircraft based on a lower ambient moisture content due to a formation of the contrail produce by the first aircraft.

In one aspect, in combination with any example computer program product above or below, where identifying the overlay area may include: identifying the first aircraft from the plurality of aircraft based on the environmental conditions and a location of the first aircraft at a first time relative to an overlay region, identifying a contrail path produced by the first aircraft traveling through the overlay region, and identifying the overlay area relative to the contrail path produced by the first aircraft, where a following aircraft traveling through the overlay area alters at least one of the contrail path produced by the first aircraft and a contrail path produced by the following aircraft.

In one aspect, in combination with any example computer program product above or below, where identifying the at least one change to the base flight plan for the second aircraft may include determining one or more updated airspeeds for the second aircraft to position the second aircraft within the overlay area, and selecting the improved flight plan may include selecting a rendezvous airspeed based on route control limits for the second aircraft and the plurality of aircraft, where the rendezvous airspeed positions the second aircraft in the overlay area in the common flight path portion. In one aspect, in combination with any example computer program product above or below, where generating the plurality of updated flight plans may include: generating a plurality of prospective flight plans for routing the second aircraft through the overlay area, and determining a route alteration value for each of the plurality of prospective flight plans, where the updated flight plans may include prospective flight plans with a route alteration value less than a route alteration limit. In some examples, the route alteration value may include one or more of: an additional fuel burn caused by a prospective flight plan of the plurality of prospective flight plans, additional emissions caused by the prospective flight plan, a delay caused by the prospective flight plan, and additional wear to the second aircraft caused by the prospective flight plan.

In one aspect, in combination with any example computer program product above or below, the operation further may include: providing the improved flight plan to a flight plan arbiter for approval, and receiving an approval to implement the improved flight plan at the second aircraft.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts example aircraft producing environmental impacts, according to aspects of the present disclosure.

FIG. 2 depicts an example of aircraft overlay routing coordination, according to aspects of the present disclosure.

FIG. 3 depicts example flight plans within an overlay area, according to aspects of the present disclosure.

FIG. 4 illustrates a data processing architecture, according to aspects of the present disclosure.

FIG. 5 is a flowchart of a method for determining an improved flight plan for overlay objectives, according to aspects of the present disclosure.

FIG. 6 illustrates a computing device, according to aspects of the present disclosure.

### DETAILED DESCRIPTION

The present disclosure relates to systems and methods for producing aircraft routes to allow for a following or second aircraft to reduce an overall environmental impact for a group of aircraft. A following aircraft flying or otherwise traveling through a similar flight path as a leading aircraft reduces an overall environmental impact of the aircraft grouping by reducing a geographic scope of various aircraft emissions including reduced aircraft fuel emissions, noise emissions, and reduced production and persistence of contrails.

Aircraft operators, such as commercial airlines, have large incentives to reduce an overall environmental impact of its aircraft fleet in operation. For example, having aircraft travel in overlaid flight paths may reduce an amount of contrails produced by the aircraft group and thus providing an advantage to the aircraft and reducing its environmental impact overall. These concerns grow more important as both regulatory agencies and consumer bases across the world increasingly require decreased environmental impacts from various industries, including the aviation industry. However, the vast number of aircraft and flight operations, along with the variable and changing routes that the aircraft travel along make efficiently coordinating overlay flight paths difficult.

For example, general aviation flight procedures prevents aircraft from flying optimal or overlaid flight paths, while also producing additional contrails in the atmosphere. Moreover, manual simultaneous overlaying of flight paths or proactive dispersal of contrails using close formation or follow along flights with two aircraft requires significant pilot training, coordination, fatiguing manual flight, and poses a risk of collision that is inappropriate for revenue passenger carriage and most civil aircraft flight operations.

The systems and methods described herein provide for identifying overlay areas for aircraft, and determining from various factors and variables an improved flight plan to take advantage of overlay flight routing. These improved flight plans reduce an environmental impact of an aircraft while accounting for a general operation of the aircraft such that reducing the environmental impacts does not reduce a given range of the aircraft for a given fuel capacity or cause other operational/mechanical challenges to the aircraft.

The systems and methods described also provide for reducing an environmental impact of aircraft during flight operations. In some examples, the improved fuel efficiency and general operation of the aircraft offers improved environmental outcomes by reducing an amount of contrails produced by the aircraft and flight operations overall. Moreover, in some examples, excessive numbers of contrails produced by many aircraft have been shown to negatively affect the environment. The aircraft flying through overlay areas for at least some portion of flight operations reduces this environmental impact by also reducing the number contrail and the persistence of contrails produced by the plurality of aircraft.

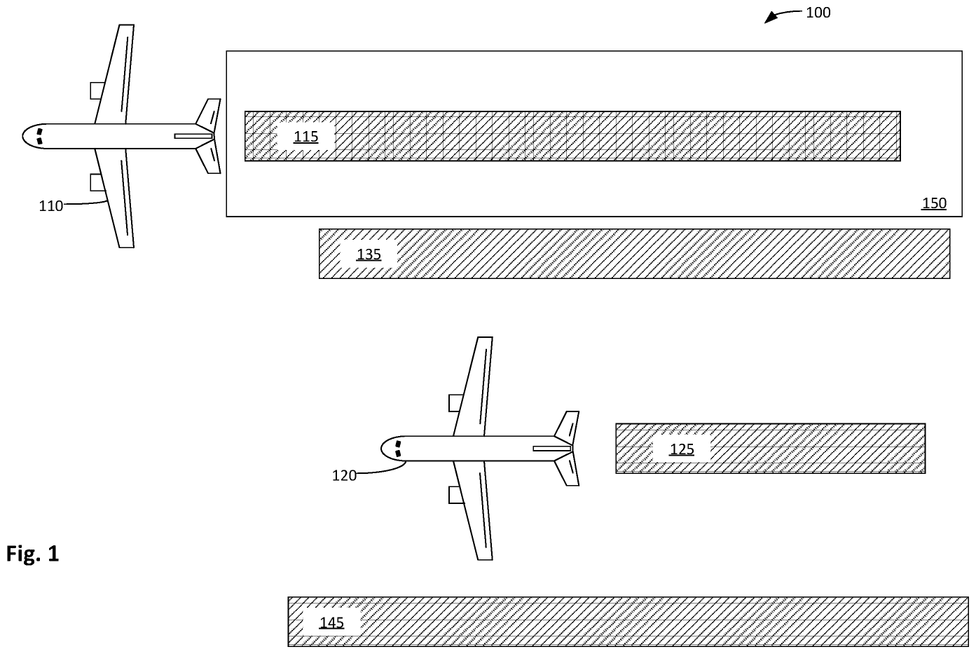

FIG. 1 depicts example aircraft producing environmental impacts, according to aspects of the present disclosure. An environment 100 includes a plurality of aircraft including a first aircraft 110 and a second aircraft 120. The environment 100 may include a specific airspace or geographic region through which the aircraft conduct flight operations. Each of the aircraft in flight produce various environmental impacts in the environment 100. In the examples herein, the environmental impacts and reducing the environmental impacts are discussed in terms of contrails; however, the environmental impacts may include any type of impact that may be reduced by utilizing overlay flight routing as described herein.

In some examples, as the first aircraft 110 travels or otherwise flies through an airspace of the environment 100, the first aircraft 110 produces a contrail 115. In some examples, the contrail 115 includes condensed water and/or ice crystals formed by condensation caused by fuel emissions of the first aircraft 110 and/or from pressure changes on various components of the aircraft while in flight (e.g., pressures changes at a wing tip, engine, etc.). The second aircraft 120 also produces a contrail 125 in the environment 100. In some examples, the contrails may cause various environmental impacts. For example, contrails may cause various levels of alterations to heat radiation in the environment 100 including preventing heat energy from radiating out of the environment 100 (e.g., radiating out of the lower atmosphere of Earth and into space).

While contrails, including the contrails 115 and 125 may dissipate in some ambient conditions of the environment 100, contrails may also persist in the environment 100 for long periods of time. For example, persistent contrails 135 and 145 are present in the environment 100 for a period of time after aircraft which produced the persistent contrails have traveled out of airspace of the environment 100. The contrails 115 and 125 and the persistent contrails 135 and 145 together may cause the environmental impacts described above, including trapping heat radiation within the environment 100.

In some examples, each of the contrails 115 and 125, including impacts from the contrails, may be disrupted or reduced by a following aircraft traveling within an overlay area. For example, the contrail 115 produced by the first aircraft 110 includes an overlay area 150 associated with the contrail 115. An aircraft, such as the second aircraft 120 traveling through the overlay area 150 may disrupt the contrail 115 causing at least some level of dissipation of the contrail 115 and thus reducing the ability of the contrail 115 to trap heat radiation in the environment 100. Additionally, the following aircraft, such as the second aircraft 120, may produce a smaller contrail or no contrail in the overlay area 150 due to the reduction of ambient moisture for contrail formation within the overlay area 150. The following aircraft, such as the second aircraft 120, may also produce a contrail in the overlay area 150 which is overlaid on the contrail 115 such that the overall impact of the two controls is reduced compared to contrails at different locations outside of the overlay area 150.

In some examples, the second aircraft 120 is positioned to travel behind the first aircraft 110 and within the overlay area 150 to safely reduce the environmental impacts of both the first aircraft 110 and the second aircraft 120. The improved flight plans described herein provide adequate spacing to avoid any physical or unsafe interaction between the first aircraft 110 and the second aircraft 120 while allowing the second aircraft 120 to fly within the overlay area 150.

In some examples, ambient conditions and altered flight plans for the aircraft may not provide favorable environmental impact mitigation. For example, various environmental/ambient conditions including temperature, ambient winds, precipitation, and other factors may reduce the chance of contrail formation such that the contrails 115 and 125 do not form, or upon formation, dissipate quickly while the respective aircraft travel through the environment 100. Additionally, a distance between the first aircraft 110 and the second aircraft 120 or a difference between the routes of the aircraft discussed below may prevent an efficient alteration of flight plans for the respective aircraft and thus reducing the potential reduction of environmental impacts of traveling through the overlay area 150.

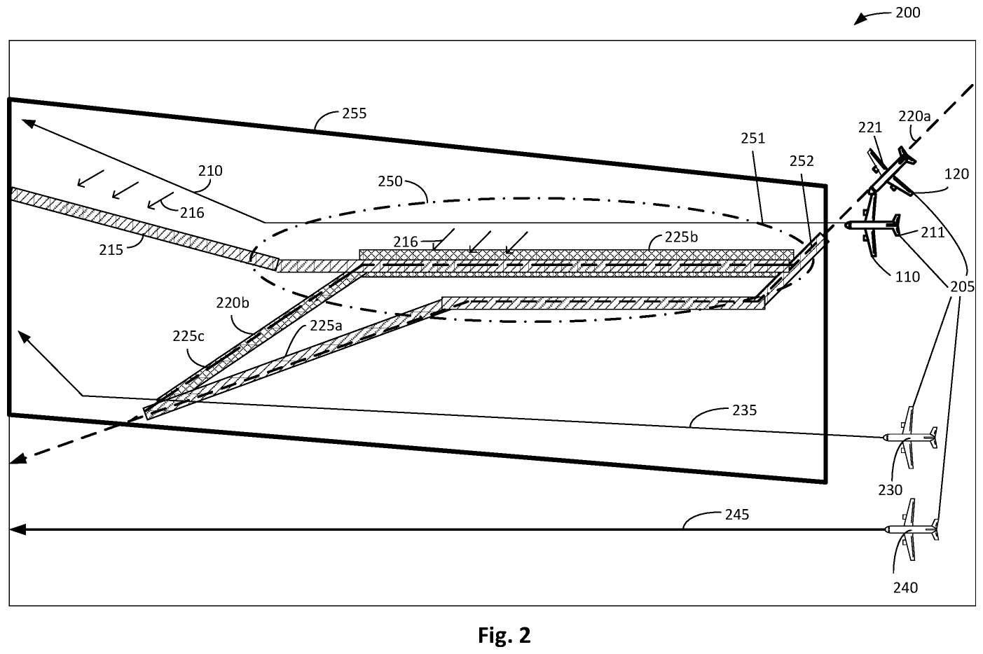

Additionally, the challenge remains to coordinate the operation of the first aircraft 110 and the second aircraft 120 while ensuring that the second aircraft 120 and the first aircraft achieve overlay objectives, such as reducing an environmental impact of both aircraft. In some examples, the first aircraft 110 and the second aircraft 120 may be operated by a same operator, such as a same airline. The first aircraft 110 and the second aircraft 120 may also be operated by different operators. For example, the first aircraft 110 may be operated by a first airline and the second aircraft 120 may be operated by a second airline. In both examples, a coordination of the travel paths to pass through the overlay area 150 requires route improvement and coordination as described in relation to FIGS. 2-6.

FIG. 2 depicts an example of aircraft overlay routing coordination, according to aspects of the present disclosure. FIG. 2 includes an overlay region 200. In some examples, environmental conditions in the overlay region 200 indicate that contrail formation is possible or likely at a given time. For example, atmospheric conditions, including temperature, ambient moisture, etc. in the overlay region 200 may indicate that aircraft flying through the overlay region 200 will likely cause contrail formation via fuel emissions, pressure changes on the aircraft, or other contrail forming mechanisms.

In some examples, a plurality of aircraft 205 travel through the overlay region 200 within a given time period. For example, the plurality of aircraft 205 may all fly through the overlay region 200 within a given time (e.g., minutes) of each other such that routes associated with each of the plurality of aircraft 205 may be potentially altered to mitigate environmental impacts of the plurality of aircraft, including reducing the formation of contrails in the overlay region 200.

In some examples, the plurality of aircraft 205 include first aircraft 110, second aircraft 120, third aircraft 230, and fourth aircraft 240, where each of the plurality of aircraft are associated with a flight route. For example, a first route 210, for the first aircraft 110, a second route 220a, for the second aircraft 120, a third route 235 for a third aircraft 230, and a fourth route 245 for the fourth aircraft 240, may all include portions of a flight route that travel through the overlay region 200.

In some examples, the first route 210, the second route 220a, the third route 235, and the fourth route 245 are preplanned or standard travel routes for the respective aircraft as they travel to their respective destinations. For example, the first aircraft 110 is traveling along first route 210 to a destination, the second aircraft 120 is traveling along second route 220a to another destination, and the third aircraft 230 is traveling along third route 235 to another destination (while described herein as different destinations, two or more of the respective routes may also provide routes to a same destination).

In some examples, each of the aircraft traveling along the respective routes produces environmental impacts such as contrails. For example, the first aircraft 110 flying along the first route 210 produces contrail 215 and the second aircraft 120 flying along the second route 220a produces contrail 225b. The third aircraft 230, fourth aircraft 240, and other aircraft of the plurality of aircraft 205 may also produce contrails (not shown in FIG. 2) in the overlay region 200.

In some examples, a first or leading aircraft traveling through the overlay region 200 is selected as a lead contrail aircraft. For example, the first aircraft 110 may travel through the overlay area 255 at a first time before the second aircraft 120 and the third aircraft 230 such that the contrail 115 forms in the overlay region 200. In some examples, the overlay area 255 is a contrail mitigation area as described herein, where contrails from one or more aircraft may be altered to reduce an environmental impact of the contrails.

As described above in FIG. 1, the contrail 215 is associated with an overlay area 255 in the overlay region 200. In some examples, the overlay area 255 includes an area of an airspace that provides overlay objectives when a following aircraft passes through the overlay area within a given period of time. For example, the overlay area 255 may include an area with reduced ambient moisture due to the formation of the contrail 215. Additionally, the overlay area 255 may include an area where the contrail 215 may drift due to wind or other environmental conditions.

For example, at a second time after the first aircraft 110 has passed through the overlay region 200, the contrail 215 has drifted from an original location along the first route 210 to the location as depicted in FIG. 2, due to winds 216. In some examples, a following aircraft of the plurality of aircraft 205 traveling through the overlay area 255 reduces contrail 215 and/or reduces the contrail generated by the follow aircraft.

As shown in FIG. 2, the second aircraft 120 and the third aircraft 230 both pass through the overlay area 255 when traveling along the planned flight paths. The fourth aircraft 240 does not pass through overlay area 255 when traveling along its flight path. In some examples, the third route 235 does not have any associated updated flight plans that allow for an alteration of the third route 235 within route alteration limits.

For example, while the third route 235 passes through the overlay area 255, an alteration to its airspeed, route, altitude, etc. may cause the third aircraft 230 to operate inefficiently. For example, the third aircraft 230 would have to consume too much fuel or cause a delay in its itinerary in order to alter its route to mitigate environmental effects in the overlay area 255.

In another example, a route of a following aircraft has a common flight path portion. For example, common flight path portion 250 includes the first route 210 and the associated contrail 215 and the second route 220a, In some examples, although the first aircraft 110 and the second aircraft 120 may have separate destinations, the aircraft may travel along a common corridor or flight path during a portion of each respective flight.

In this example, the second aircraft 120 may mitigate environmental impacts such as reducing contrail mitigation for the second aircraft 120 and the first aircraft without altering the first route 210 or the second route 220a. For example, the contrail 225a forms with a lower density or dissipates quickly due to low moisture content in the atmosphere in the common flight path portion 250 caused by the prior formation of the contrail 215. In some examples, the second route 220a and the route 220b in the common flight path portion 250 form a passive overlap that includes portions of at least two routes such that the aircraft travel through the same airspace along a same path in the passive overlap, without alteration to the aircraft routes.

In order to ensure the first aircraft 110 (and contrail 215) and/or the second aircraft 120 are positioned within the common flight path portion 250 with a given time, the first aircraft 110 and/or the second aircraft 120 may alter their airspeeds, altitudes, etc., to travel at respective rendezvous airspeeds. In some examples, the rendezvous airspeeds position the respective aircraft to travel through the overlay area 255 and the common flight path portion 250 in order to effectively mitigate environmental impacts. For example, the second aircraft 120 alters its airspeed in order to ensure that the second aircraft 120 travels along the second route 220a at a time that will provide mitigation of contrail 215 and/or the contrail 225a.

For example, at a first location 211 the first aircraft 110 may update its base flight plan to travel at rendezvous airspeed slower than its base flight plan airspeed until it reaches an overlay point 251, and the second aircraft 120, at the second location 221, may update its base flight plan to travel at a rendezvous airspeed faster than its base flight plan airspeed until it reaches an overlay point 252. In some examples, the first aircraft 110 and the second aircraft 120 may travel relative to each other as a formation or a pair. In another example, while the aircraft alter their respective speeds, there is no requirement that the first aircraft 110 and the second aircraft 120 travel in a formation through the common flight path portion 250 or the overlay area 255.

In some examples, updates to the base flight plans may also include updates/changes to an altitude of the first aircraft and the second aircraft to position the aircraft in the common flight path portion 250. In some examples, the change in altitude may also be used to determine when the lead aircraft and following aircraft provides overall environmental impact mitigation such as reducing contrails in the overlay area 255.

In some examples, the improved flight plan for the following aircraft (e.g., the second aircraft 120) includes alterations to the flight route to produce proactive overlapping portions. In this example, several example overlapping routes may be examined for proactive changes to base flight plans. The base flight plans for a plurality of aircraft and routes may be examined by the overlay matching system 410 described herein to provide for environmental impact mitigation, among other benefits. In this example, the improved flight plan for the second aircraft 120 includes updated route 220b which alters the flight path for the second aircraft 120 for at least a portion of its original route, second route 220a. In this example, the second aircraft 120 travels through an airspace associated with the contrail 215. The second aircraft 120 may dissipate or disrupt the contrail 215 for the portion that the second aircraft 120 travels through the contrail. Additionally, the second aircraft 120 may produce a contrail 225b which has a lower heat holding potential compared to the contrail 225a. In another example, the contrail 225b overlays the contrail 215 such that the contrails do not cause increased adverse environmental impacts compared to two non-overlaid contrails.

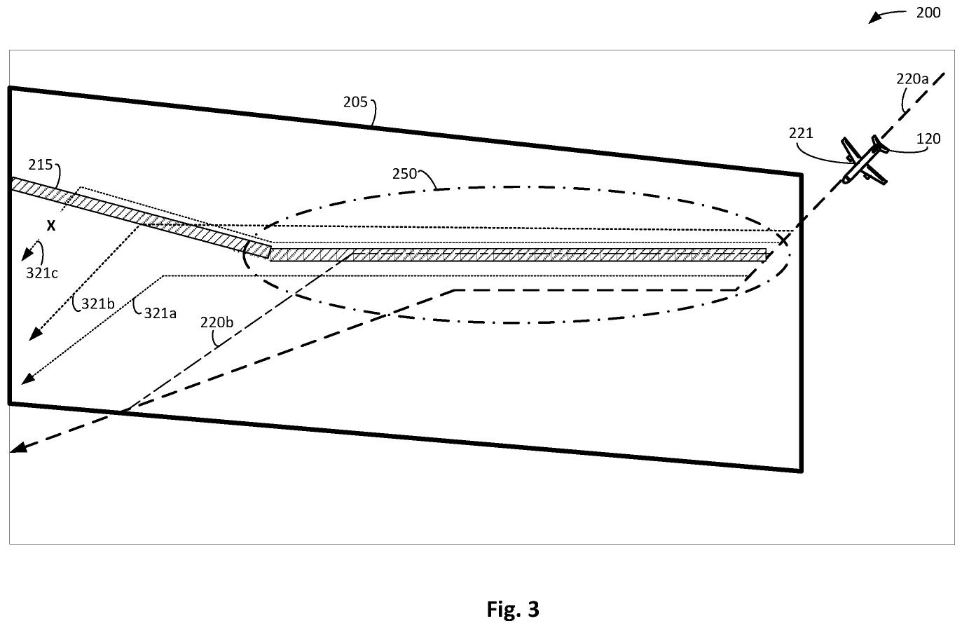

In some examples, the route 220b includes a portion which routes the aircraft back towards its original route, the second route 220a. In this example, the second aircraft 120 also produces the contrail 225c along a portion of the route 220b outside of the common flight path portion or overlay section between the route 220b and the first route 210. In the examples, described above, the improved flight plans for the second aircraft 120 and/or the first aircraft 110 provide for reduced contrails (i.e., the contrails 215, 225a, 225b, and 225c) compared to expected contrail production along the original routes for the lead and following aircraft. In some examples, the first aircraft 110 and/or the second aircraft 120 selected an improved flight plan from several updated flight as shown in FIG. 3.

FIG. 3 depicts example flight plans within an overlay area, according to aspects of the present disclosure. For ease of discussion, the examples shown in FIG. 3 include example updated flight plans for the second aircraft 120. Similar determinations may be performed for each of the plurality of aircraft 205 described in relation to FIG. 2. In this example, the second aircraft 120 includes the second route 220a, route 220b, route 321a, route 321b, and route 321c. In some examples, the routes 220b, and routes 321a-321b for the second aircraft 120 include proximate portions of the routes where base plan routes, such as the second route 220a, may be proactively altered to provide a proactive overlap of the second aircraft 120 and the common flight path portion 250.

In some examples, the second route 220a and the contrail 215 and/or the common flight path portion 250 do not intersect as the respective aircraft travel to a destination. For example, the initial route for the second aircraft 120, second route 220a, does not passively overlap in the common flight path portion 250. In order to alter the route of the second aircraft 120 into an improved portion of the common flight path portion 250, (e.g., within or overlaying the contrail 215) the second route 220a is altered into a proactively altered route 220b. In some examples, the route 220b is selected from the plurality of prospective routes which include the route 220b and the routes 321a-321c based on overlay objectives. The overlay objectives may include one or more of:

overlaying a contrail produced by the second aircraft in the overlay area with a contrail produced by the first aircraft, disrupting the contrail produced by the first aircraft, and minimizing the contrail produced by the second aircraft based on a lower ambient moisture content due to a formation of the contrail produce by the first aircraft.

In some examples, the plurality of prospective routes are generated and selected using a route alteration value for each of the plurality of prospective routes. In some examples, the prospective flights may be eliminated from consideration or not selected when a route alteration value exceeds a route alteration limit. For example, the route 321c may cause the second aircraft 120 to exceed fuel burn thresholds or cause various delays in itinerary of the second aircraft 120 or an overall airspace system.

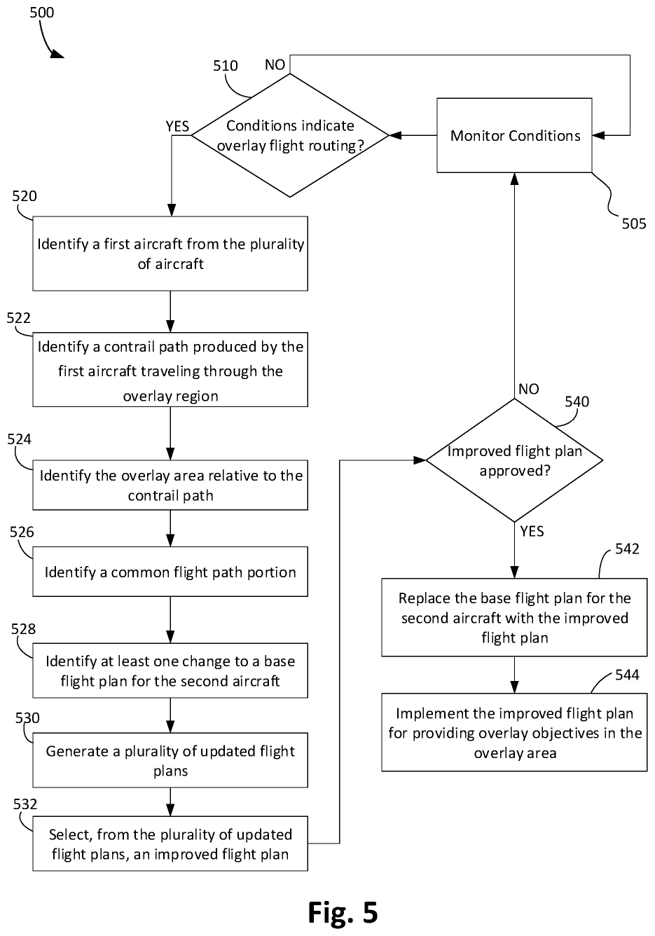

For the second aircraft 120 in FIG. 3, the updated routes include improved environmental impact mitigation among other improvements such as improved varying fuel savings, where the methods and systems described herein determine which of the prospective routes, provides the greatest reduction in environmental impacts for first aircraft and the second aircraft 120 as described herein in relation to FIG. 5.

Furthermore, in the examples shown in FIGS. 2-3, the various route updates and changes occur as the aircraft, such as the first aircraft 110, the second aircraft 120, and the plurality of aircraft 205, are underway along respective routes or are otherwise in flight. Providing improved flights plans in flight may provide dynamic and up-to-date alterations to the plurality of aircraft to provide improved flight paths as weather conditions affect the operations of the aircraft. However, in some examples, aircraft operators or other flight plan implementers may wish to determine and coordinate improved flight plans for fuel efficiency prior to the aircraft taking off.

For example referring back to FIG. 2, the first aircraft 110 may beat a first location 211 along the first route 210 and the second aircraft 120 may be at origin location at second location 221. In order to provide overlap in the common flight path portion 250, the first aircraft 110 may alter its airspeed in order to position the aircraft into the common flight path portion 250 within a time that allows for the second aircraft 120 to also pass through the common flight path portion 250 in order to improve environmental impact mitigation. Additionally, the change to the base flight plan for the second aircraft 120 may include an alteration to a departure time from the second location 221. For example, at a first location 211 the first aircraft 110 may update its base flight plan to travel at a slower airspeed and the second aircraft 120 at the origin location, the second location 221, may update its base flight plan to move up or delay take off in order to pass through the common flight path portion 250 during a time that the effects of the contrail 215 may be mitigated by the second aircraft 120.

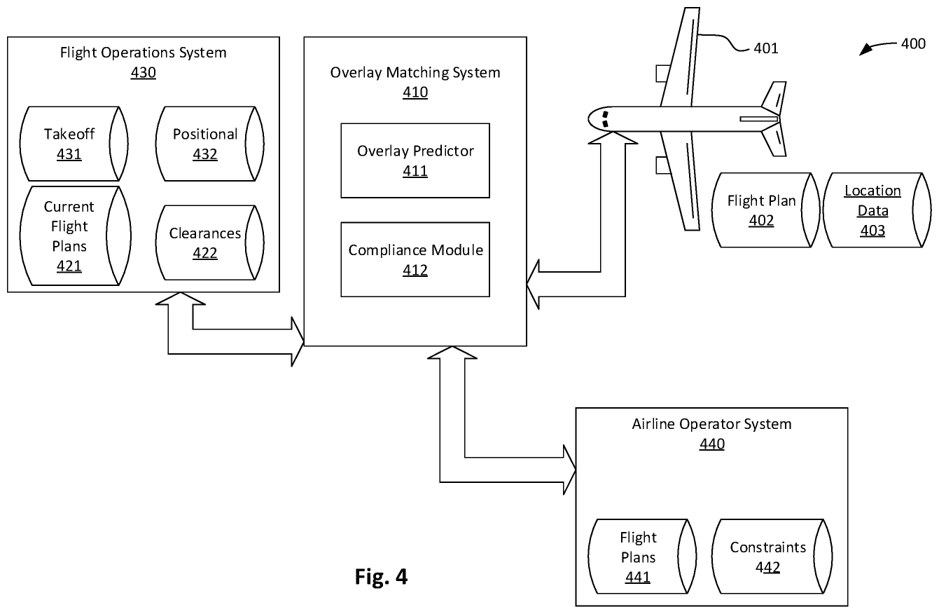

FIG. 4 illustrates a data processing architecture 400, according to aspects of the present disclosure. To group aircraft together and determine improved flight plans to improve environmental impact mitigation, an overlay matching system 410, determines and manages various flight plans and routes available to the aircraft 401 and selects an improved flight plan for aircraft, such as the first aircraft 110 and the second aircraft 120 described above.

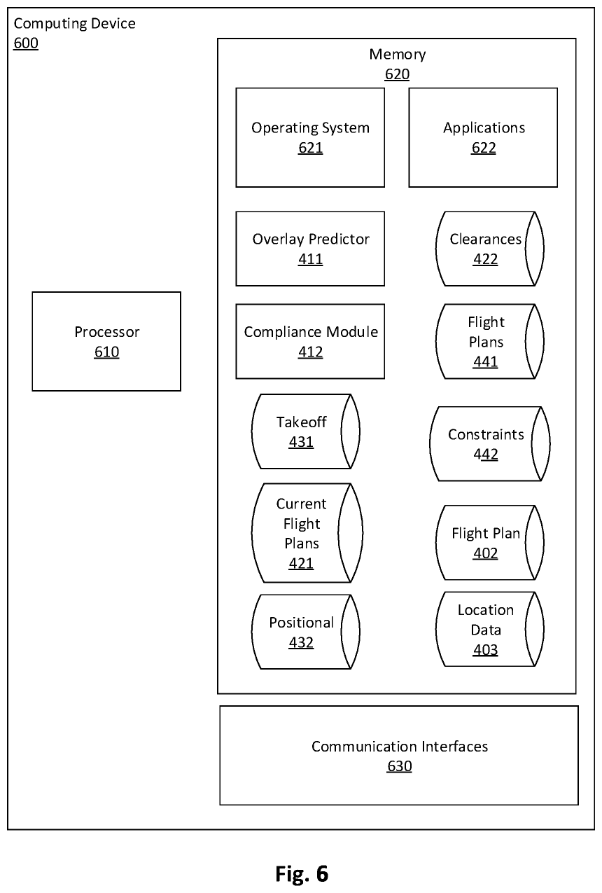

The overlay matching system 410 is in communication with the various aircraft such as aircraft 401, including at least the first aircraft 110 and second aircraft 120 described in relation to FIGS. 1-3, a flight operations system 430, and an airline operator system 440. Each of the aircraft 401, overlay matching system 410, flight operations system 430, and airline operator system 440 are representative of or include one or more computing devices, such as those described in relation to FIG. 6, that process and store various data. In various embodiments, operations of the overlay matching system 410 may be performed on dedicated hardware or as part of a cloud computing environment in various aspects. Although the aircraft 401, overlay matching system 410, flight operations system 430, and airline operator system 440 are illustrated as single systems, in various aspects, the overlay matching system 410 is in communications with several instances of each, and each instance may provide some or all of the associated data in different aspects.

For example, the aircraft 401 may provide the overlay matching system 410 with various flight plan data, such as flight plan data 402 and location data 403 for the aircraft 401. The flight plan data 402 can at least indicate a base flight plan, including the currently planned routes for the aircraft 401, as well as predicted aircraft paths and times from various onboard aircraft systems. The location data 403 can include a current location and status of the aircraft 401, including location, speed, flight status, etc.

The flight operations system 430, which can include local air traffic controller systems, remote air traffic controller systems as well as regional, national, or global navigation and tracking systems provides takeoff data 431 and positional data 432 for the airport or flight operator. In various aspects, the takeoff data 431 include scheduled times and aircraft queued for takeoff. The positional data 432 can include (ground-related) ADS-B (Automatic Dependent Surveillance—Broadcast) data for where various aircraft, such as the aircraft 401 are located. The positional data 432 may also include current aircraft positions for the aircraft 401 provided via System Wide Information

Management (SWIM). The flight operations system 430 can also include current flight plans 421 for the aircraft 401, which includes flight plans filed with air traffic controller systems, as well as clearances 422, which include clearances for each of the aircraft 401 to use various runways or flight corridors at specified times.

The airline operator system 440 also provides the overlay matching system 410 with flight plans 441 and constraints data 442. The flight plans 441 specify information about the aircraft 401 controlled by the specific airline and may include a number of passengers, a crew manifest (including duty times and “home” airports), departure and estimated time of arrival (ETA) times for a currently scheduled flight, information related to a next scheduled flight, etc., as well as baseline flight plans for each of the scheduled flights. The constraints data 442 specify various constraints for the aircraft 401 including limits to route variations as well as constraints that may affect aircraft pairing such as scheduling and other limitations.

The overlay matching system 410 receives the data from the other systems to perform overlay matching for a plurality of aircraft, and to communicate those decisions back to the various systems for further processing and analysis. For example, updated rendezvous speeds and formation airspeeds for the aircraft 401 are provided back to the aircraft 401 as well as other potential flight implementers, such as the airline operator system 440 and the flight operations system 430.

The overlay matching system 410 includes an overlay predictor 411, which identifies aircraft 401 and other aircraft to take advantage of route overlays, and generates various updated flight plans to determine an improved flight plan to provide improved environmental impact mitigation for an aircraft 401. The compliance module 412 verifies that the proposed flight plans are compatible with constraints in constraints data 442 provided by the airline operator system 440, as well as compatible with other air traffic controlled by the flight operations system 430.

In some examples, the overlay matching system 410 provides the improved flight plan to a pilot or auto-pilot system of the aircraft 401. For example, the improved flight may be accepted and implemented by an auto-pilot system aboard the aircraft 401, where the aircraft 401 implementing the changes identified by the overlay matching system 410 for the improved flight plan. Additionally, the overlay matching system 410 may also provide the improved flight plan to the airline operator system 440 and the flight operations system 430 which update their respective records of the base flight plan for the aircraft 401 and propagate the updated changes for the improved flight plan to aircraft 401.

FIG. 5 is a flowchart of a method 500 for determining an improved flight plan for overlay objectives, according to aspects of the present disclosure. Method 500 begins a block 505, where the overlay matching system 410 monitors environmental conditions in an overlay region. For example, the overlay matching system 410 monitors the environmental conditions and altitude in the overlay region 200 where contrails are likely to occur along the flight path of any affected aircraft, such as the plurality of aircraft 205.

At block 510, the overlay matching system 410 detects, based on environmental conditions in an overlay region, conditions for overlay flight routing. For example, the overlay matching system 410 detects when the temperature, ambient moisture, ambient wind, etc., in the overlay region will cause persistent controls in the overlay region 200. In an example, where the conditions do not indicate persistent contrails in the overlay region 200, method 500 returns to block 505. In an example where persistent contrails are likely, method 500 proceeds to block 520.

At blocks 520-522, the overlay matching system 410 identifies, using the environment conditions and a first route for a first aircraft, an overlay area. For example, at block 520, the overlay matching system 410 identifies a first aircraft from a plurality of aircraft based on the environmental conditions and a location of the first aircraft at a first time relative to an overlay region. In some examples, the presence of other aircraft ahead of affected aircraft is analyzed by the overlay matching system 410. A lead contrail generating aircraft is selected from the aircraft ahead of other aircraft. For example, the first aircraft 110 is identified as passing through the overlay region 200 before other aircraft of the plurality of aircraft 205. Criteria for selection include the distance from the affected aircraft (e.g., the second aircraft 120) entry point of the contrail region, overlay region 200, a time since a candidate lead aircraft (e.g., the first aircraft 110) passed into the overlay region 200 and/or the overlay area 255.

At block 522, the overlay matching system 410 identifies a contrail path produced by the first aircraft traveling through the overlay region. For example, the overlay matching system 410 determines the production and location of the contrail path, contrail 215, including any associated drift or dissipation of the contrail path, contrail 215.

At block 524, the overlay matching system 410 identifies an overlay area relative to the contrail path produced by the first aircraft. In some examples, a following aircraft traveling through the overlay area alters at least one of the contrail path produced by the first aircraft and a contrail path produced by the following aircraft. For example, the overlay matching system 410 identifies the overlay area 255 associated with the contrail path, contrail 215.

At block 526, the overlay matching system 410 identifies, from the overlay area and a plurality of routes for a plurality of aircraft, a common flight path portion including the overlay area and a second route from the plurality of routes for a second aircraft of the plurality of aircraft. For example, the overlay matching system 410 identifies the second aircraft 120 and the second route 220a as being within the common flight path portion 250. In some examples, the common flight path portions for the aircraft include both location similarities and time similarities for the aircraft and/or the produced contrails (e.g., the contrail 215). For example, the first and second aircraft travel in similar areas at similar times. In some examples, the first and second aircraft may travel along the same path for some distance, thus providing a passive overlap of the flight path portions. In other examples, the first and second aircraft may not travel along a same corridor or flight path, but the routes may be close to each other (e.g., proximate paths).Additionally, in some examples, the overlay matching system 410 may filter out aircraft with common flight path portions, but are less likely to advantageously travel through a common flight path portion to reduce environmental impacts.

At block 528, the overlay matching system 410 identifies at least one change to a base flight plan for the second aircraft to provide a rendezvous for the second aircraft to fly within the overlay area over the common flight path portion. In some examples, identifying the at least one change to the base flight plan for the second aircraft includes determining one or more updated airspeeds for the second aircraft 120 to position the second aircraft within the overlay area 255 and the commons flight path portions.

At block 530, the overlay matching system 410 generates a plurality updated flight plans. In some examples, this includes generating a plurality of prospective flight plans for routing the second aircraft through the overlay area. In some examples, generating the prospective flight plans includes determining a route alteration value for each of the plurality of prospective flight plans, where the updated flight plans include prospective flight plans with a route alteration value less than a route alteration limit.

The route alteration limits may include limits on additional fuel consumption, additional emissions including fuel emissions, noise emissions, etc., caused by a flight alteration.

For example, the overlay matching system 410, using the overlay predictor 411 and compliance module 412, generates a plurality of optional updated flight plans.

For example, the plurality of updated flight plans may include various combinations of rendezvous air operations, altitude changes, various rendezvous and divergence points along common path portions, as well, as various optional route updates for at least the second aircraft. In some examples, the updated flight plans may also include at least one change to the base flight plan of the first aircraft. The updated flight plans can also be crosschecked with flight plans 441 and constraints data 442 in order to ensure than any changes to the flight plans will not violate commercial or civil constraints imposed by the aircraft operators. The updated flights may also be crosschecked with flight operations system 430 to ensure that aircraft control in the airspace is maintained and that updated flight plans do not pose a safety or other risk to plurality of aircraft 205 or other aircraft traveling through the airspace.

While shown as distinct examples, the overlay matching system 410 may also generate optional flight plans from each of the examples shown in FIGS. 1-3. For example, for the second aircraft -120, the overlay matching system 410 may generate flight plans including any type of overlap in the common flight path portion 250 and any combination of the above examples in order to determine an improved flight plan.

A block 532, the overlay matching system 410 selects, from the plurality of updated flight plans, an improved flight plan for providing overlay objectives in the overlay area. In some examples, selecting the improved flight plan includes selecting a rendezvous air operations based on route control limits for the second aircraft and the plurality of aircraft, where the rendezvous air operations position the second aircraft in the overlay area in the common flight path portion. The generation of the prospective and updated plans and the selection of the improved plan uses several consideration factors.

For example, a recommended flight path deviation in the generated prospective flight plans may be generated using one or more possible overlay objectives. These overlay objectives may include positioning contrails of the following aircraft to overlay the contrails of the lead aircraft (e.g., the contrail 225b overlaying the contrail 115). The overlay objectives may also include to disrupt or dissipate contrails of the lead aircraft (e.g., the second aircraft 120 disrupts the contrail 215) and/or to fly in the overlay area 255 where much of the moisture in the air necessary for the formation of persistent contrails has been consumed into contrails (e.g., the contrail 215) by the lead aircraft so the probability of persistent contrail formation by the affected aircraft is reduced.

In some examples, the at least one change to a base flight plan for the second aircraft is also based on an offset from the lead aircraft by a distance corresponding to the wind drift (e.g., drift caused by wind 216) of the lead aircraft's contrails in the time between the lead and affected aircraft passing through the common flight path portion 250.

In some examples, a duration and distance of a route change may be bounded by a predetermined maximum allowable additional fuel burn above the original route, or other criteria that might include the total economic impact (fuel, delay, maintenance costs, etc.) and environmental impact (total emissions, altitude of emissions, etc.). In some examples, upon reaching the maximum allowable offset fuel burn from the original route, the prospective route will include a return to the original route.

In some examples, the prospective route may include limits to keep the aircraft separated by airspace traffic navigation distance, time, and altitude rules. This has the benefit of facilitating approval of the route change by an air traffic control authority, eliminating the need for formation flight, and eliminating the need for direct coordination between the lead and following aircraft.

As noted above, at block 532, the overlay matching system 410 selects, from the plurality of updated flight plans, an improved flight plan for providing overlay objectives in the overlay area. In some examples, the improved plan provides the overlay objectives at a lowest resource cost or alteration to an original route of the second aircraft, the second route 220a. For example, the route 220b is selected from the prospective routes as providing one or more of the overlay objectives with a lowest alteration from the second route 220a.

At block 540 the overlay matching system 410 provides the improved flight plan to a flight plan arbiter for approval. In some examples, the overlay matching system 410 provides the improved flight plan to a pilot or auto-pilot system of the aircraft 401. For example, the improved flight may be accepted and implemented by an auto-pilot system aboard the aircraft 401, where the aircraft 401 implementing the changes identified by the overlay matching system 410 for the improved flight plan. Additionally, the overlay matching system 410 may also provide the improved flight plan to the airline operator system 440 and the flight operations system 430 which update their respective records of the base flight plan for the aircraft 401 and propagate the updated changes for the improved flight plan to aircraft 401. In an example where an autopilot, pilot, or other system rejects the improved flight plant, the overlay matching system 410 may provide additional options from the updated flight plans to the arbiter. In an example, where any update flight plan is rejected the method 500 returns to block 505 to continue monitoring for environmental conditions.

In some examples, at block 540, the overlay matching system 410 receives an approval to implement the improved flight plan at the second aircraft and proceeds to block 542 where the overlay matching system 410 replaces the base flight plan for the second aircraft with the improved flight plan. For example, the overlay matching system 410 may provide the improved flight plan to a flight crew aboard the second aircraft, (e.g., the flight crew aboard the second aircraft 120) and a flight operator for the second aircraft (e.g., an airline route coordinator for the second aircraft 120). The improved flight plan may include updated flight plans including updated speeds and routes, as well as expected environmental impact reductions, and potential time changes for arrival at a destination, among other factors and information. The overlay matching system 410 also replaces the base flight plan with the improved flight plan in flight plan data 402, flight plans 441, and current flight plans 421 in order to provide consistency for coordination of the flight plans as well as to cause the aircraft 401 to implement the improved flight plan.

In some examples, the overlay matching system 410 also replaces the base flight plan for the first aircraft with the improved flight. The improved flight plan may also be provided to one of the flight crew aboard the first aircraft, (e.g., a flight crew aboard the first aircraft 110) and a flight operator for the first aircraft. In some examples, the improved flight plan may be accepted or rejected by any of the systems receiving the improved flight plan (e.g., the aircraft 401, the airline operator system 440, and the flight operations system 430). For example, when environmental impact reduction or other factors do not factor into a flight operator's overall goal for flight operations, the various systems may reject the improved flight plan and/or continue along the base flight plan. The improved flight plan may also be accepted and the operation of the second aircraft adjusted to begin executing the improved flight plan.

In another example, both aircraft including a lead and following aircraft may need to begin execution of the improved flight plan (adjusted for each role as the first or second aircraft in a pair) in order to ensure the aircraft pass through the common flight path portion. In some examples, the overlay matching system 410 provides further coordination between the aircraft pair as the aircraft are provided and being implementation of the improved flight plan in order to ensure that both aircraft have accept the improved flight plan and begin implementation.

At block 544, the overlay matching system 410 and implements the improved flight plan for providing overlay objectives in the overlay area for the second aircraft. For example, the overlay matching system 410 causes an auto-pilot system aboard the aircraft 401 (as the second aircraft) to begin implementing steps to change airspeed, re-route, or otherwise begin implementing the improved flight plan. In some examples, such as when the improved flight plan includes changes to the base flight plan of the first aircraft, the overlay matching system 410 also performs the improved flight plan at the first aircraft for the reduced environmental impacts for the first and second aircraft.

In some examples, the overlay matching system 410 implements the improved flight plan via the flight operations system 430 and/or the airline operator system 440, where the flight operations system 430 and the airline operator system 440 relay the improved flight plan(s) to respective aircraft or otherwise cause the first aircraft and the second aircraft to implement the improved flight plan.

FIG. 6 illustrates a computing device, according to aspects of the present disclosure. FIG. 6 illustrates example computing components of a computing device 600 or other processing system as may be used to provide overlay matching as described in the present disclosure by one or more of the overlay matching system 410, flight operations system 430, airline operator system 440, and/or an onboard computer for an aircraft 401.

The computing device 600 includes a processor 610, a memory 620, and an interface 630. The processor 610 and the memory 620 provide computing functionality to run various programs and/or operations for the computing device 600, including the storage and retrieval of the various data described herein.

The processor 610, which may be any computer processor or computer processors capable of performing the functions described herein, executes commands based on inputs received from a user and the data received from the interface 630.

The interface 630 connects the computing device 600 to external devices, such as, for example, external memory devices, external computing devices, a power source, a wireless transmitter, etc., and may include various connection ports (e.g., Universal Serial Bus (USB), Firewire, Ethernet, coaxial jacks) and cabling. The interface 630 is used to send and receive between computing devices, such as computing device 600 and to communicate alerts (including go, no-go, and caution alerts) to aircraft 401 and/or the operators thereof.

The memory 620 is a memory storage device that generally includes various processor-executable instructions, that when executed by the processor 610, perform the various functions discussed herein. The processor-executable instructions may generally be described or organized into various “applications” or “modules” in the memory 620, although alternate implementations may have different functions and/or combinations of functions. The memory 620 also generally includes data structures that store information for use by or output by the various applications or modules. In the present disclosure, the memory 620 includes at least instructions for an operating system 621 and one or more application(s) 622. The memory 620 may be one or more memory devices, such as, for example, Random Access Memory (RAM), Read Only Memory (ROM), flash memory, or any other type of volatile or non-volatile storage medium that includes instructions that the processor 610 may execute.

When the computing device 600 provides the functionality of the overlay matching system 410 (per FIG. 4), the memory 620 includes processor executable instructions, such as computer-readable program code executable to provide the functionalities thereof described in the present disclosure. In some aspects, the memory 620 includes databases for locally caching data for analysis by the overlay predictor 411 and the compliance module 412, but can also use data maintained on and received via the interface 630 from a, a flight operations system, an airline operator system, and/or an aircraft including the takeoff data 431, current flight plans 421, positional data 432, clearances 422, flight plans 441, constraints data 442, flight plan data 402, and location data 403, etc.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer-readable storage medium(s) having computer-readable program code embodied thereon.

Program code embodied on a computer-readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer-readable medium that can direct a computer, other programmable data processing apparatus, or other device to function in a particular manner, such that the instructions stored in the computer-readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figs illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figs. For example, two blocks shown in succession may in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method comprising:
detecting, based on environmental conditions in an overlay region, conditions for overlay flight routing;
identifying, using the environmental conditions and a first route for a first aircraft, an overlay area;
identifying, from the overlay area and a plurality of routes for a plurality of aircraft, a common flight path portion comprising the overlay area and a second route from the plurality of routes for a second aircraft of the plurality of aircraft;
identifying at least one change to a base flight plan for the second aircraft to provide a rendezvous for the second aircraft to fly within the overlay area over the common flight path portion;
generating a plurality of updated flight plans with one or more of the at least one change to the base flight plan for the second aircraft;
selecting, from the plurality of updated flight plans, an improved flight plan for providing overlay objectives in the overlay area;
replacing the base flight plan for the second aircraft with the improved flight plan; and
implementing the improved flight plan for providing the overlay objectives in the overlay area for the second aircraft.

2. The method of claim 1, wherein the overlay area comprises a contrail mitigation area, and wherein the overlay objectives comprises one or more of:
overlaying a contrail produced by the second aircraft in the overlay area with a contrail produced by the first aircraft;
disrupting the contrail produced by the first aircraft; and
minimizing the contrail produced by the second aircraft based on a lower ambient moisture content due to a formation of the contrail produce by the first aircraft.

3. The method of claim 1, wherein identifying the overlay area comprises:
identifying the first aircraft from the plurality of aircraft based on the environmental conditions and a location of the first aircraft at a first time relative to the overlay region;
identifying a contrail path produced by the first aircraft traveling through the overlay region; and
identifying the overlay area relative to the contrail path produced by the first aircraft, wherein a following aircraft traveling through the overlay area alters at least one of the contrail path produced by the first aircraft and a contrail path produced by the following aircraft.

4. The method of claim 1, wherein:
identifying the at least one change to the base flight plan for the second aircraft comprises determining one or more updated airspeeds for the second aircraft to position the second aircraft within the overlay area, and
selecting the improved flight plan comprises selecting a rendezvous airspeed based on route control limits for the second aircraft and the plurality of aircraft, wherein the rendezvous airspeed positions the second aircraft in the overlay area in the common flight path portion.

5. The method of claim 1, wherein generating the plurality of updated flight plans comprises:
generating a plurality of prospective flight plans for routing the second aircraft through the overlay area; and
determining a route alteration value for each of the plurality of prospective flight plans, wherein the updated flight plans comprise prospective flight plans with a route alteration value less than a route alteration limit.

6. The method of claim 5, wherein the route alteration value comprises one or more of:
an additional fuel burn caused by a prospective flight plan of the plurality of prospective flight plans,
additional emissions caused by the prospective flight plan, a delay caused by the prospective flight plan, and additional wear to the second aircraft caused by the prospective flight plan.

7. The method of claim 1, further comprising:
providing the improved flight plan to a flight plan arbiter for approval; and
receiving an approval to implement the improved flight plan at the second aircraft.

8. A system, comprising:
a processor;
a memory storage device including instructions that when executed by the processor perform an operation, comprising:
detecting, based on environmental conditions in an overlay region, conditions for overlay flight routing;
identifying, using the environmental conditions and a first route for a first aircraft, an overlay area;
identifying, from the overlay area and a plurality of routes for a plurality of aircraft, a common flight path portion comprising the overlay area and a second route from the plurality of routes for a second aircraft of the plurality of aircraft;
identifying at least one change to a base flight plan for the second aircraft to provide a rendezvous for the second aircraft to fly within the overlay area over the common flight path portion;
generating a plurality of updated flight plans with one or more of the at least one change to the base flight plan for the second aircraft;
selecting, from the plurality of updated flight plans, an improved flight plan for providing overlay objectives in the overlay area;
replacing the base flight plan for the second aircraft with the improved flight plan; and
implementing the improved flight plan for providing the overlay objectives in the overlay area for the second aircraft.

9. The system of claim 8, wherein the overlay area comprises a contrail mitigation area, and wherein the overlay objectives comprises one or more of:
overlaying a contrail produced by the second aircraft in the overlay area with a contrail produced by the first aircraft;
disrupting the contrail produced by the first aircraft; and
minimizing the contrail produced by the second aircraft based on a lower ambient moisture content due to a formation of the contrail produce by the first aircraft.

10. The system of claim 8, wherein identifying the overlay area comprises:
identifying the first aircraft from the plurality of aircraft based on the environmental conditions and a location of the first aircraft at a first time relative to the overlay region;
identifying a contrail path produced by the first aircraft traveling through the overlay region; and
identifying the overlay area relative to the contrail path produced by the first aircraft, wherein a following aircraft traveling through the overlay area alters at least one of the contrail path produced by the first aircraft and a contrail path produced by the following aircraft.

11. The system of claim 8, wherein:
identifying the at least one change to the base flight plan for the second aircraft comprises determining one or more updated airspeeds for the second aircraft to position the second aircraft within the overlay area, and
selecting the improved flight plan comprises selecting a rendezvous airspeed based on route control limits for the second aircraft and the plurality of aircraft, wherein the rendezvous airspeed positions the second aircraft in the overlay area in the common flight path portion.

12. The system of claim 8, wherein generating the plurality of updated flight plans comprises:
generating a plurality of prospective flight plans for routing the second aircraft through the overlay area; and
determining a route alteration value for each of the plurality of prospective flight plans, wherein the updated flight plans comprise prospective flight plans with a route alteration value less than a route alteration limit.

13. The system of claim 12, wherein the route alteration value comprises one or more of:
an additional fuel burn caused by a prospective flight plan of the plurality of prospective flight plans,
additional emissions caused by the prospective flight plan,
a delay caused by the prospective flight plan, and
additional wear to the second aircraft caused by the prospective flight plan.

14. The system of claim 8, wherein the operation further comprises:
providing the improved flight plan to a flight plan arbiter for approval; and
receiving an approval to implement the improved flight plan at the second aircraft.

15. A computer program product, the computer program product comprising:
a computer-readable storage medium having computer-readable program code embodied therewith, the computer-readable program code executable by one or more computer processors to perform an operation, the operation comprising:
detecting, based on environmental conditions in an overlay region, conditions for overlay flight routing;
identifying, using the environmental conditions and a first route for a first aircraft, an overlay area;
identifying, from the overlay area and a plurality of routes for a plurality of aircraft, a common flight path portion comprising the overlay area and a second route from the plurality of routes for a second aircraft of the plurality of aircraft;
identifying at least one change to a base flight plan for the second aircraft to provide a rendezvous for the second aircraft to fly within the overlay area over the common flight path portion;
generating a plurality of updated flight plans with one or more of the at least one change to the base flight plan for the second aircraft;
selecting, from the plurality of updated flight plans, an improved flight plan for providing overlay objectives in the overlay area;
replacing the base flight plan for the second aircraft with the improved flight plan;
and implementing the improved flight plan for providing the overlay objectives in the overlay area for the second aircraft.

16. The computer program product of claim 15, wherein the overlay area comprises a contrail mitigation area, and wherein the overlay objectives comprises one or more of:
overlaying a contrail produced by the second aircraft in the overlay area with a contrail produced by the first aircraft;
disrupting the contrail produced by the first aircraft; and
minimizing the contrail produced by the second aircraft based on a lower ambient moisture content due to a formation of the contrail produce by the first aircraft.

17. The computer program product of claim 15, wherein identifying the overlay area comprises:
identifying the first aircraft from the plurality of aircraft based on the environmental conditions and a location of the first aircraft at a first time relative to the overlay region;
identifying a contrail path produced by the first aircraft traveling through the overlay region; and
identifying the overlay area relative to the contrail path produced by the first aircraft, wherein a following aircraft traveling through the overlay area alters at least one of the contrail path produced by the first aircraft and a contrail path produced by the following aircraft.

18. The computer program product of claim 15, wherein:
identifying the at least one change to the base flight plan for the second aircraft comprises determining one or more updated airspeeds for the second aircraft to position the second aircraft within the overlay area, and
selecting the improved flight plan comprises selecting a rendezvous airspeed based on route control limits for the second aircraft and the plurality of aircraft, wherein the rendezvous airspeed positions the second aircraft in the overlay area in the common flight path portion.

19. The computer program product of claim 15, wherein generating the plurality of updated flight plans comprises:
generating a plurality of prospective flight plans for routing the second aircraft through the overlay area; and
determining a route alteration value for each of the plurality of prospective flight plans, wherein the updated flight plans comprise prospective flight plans with a route alteration value less than a route alteration limit, wherein the route alteration value comprises one or more of:
an additional fuel burn caused by a prospective flight plan of the plurality of prospective flight plans,
additional emissions caused by the prospective flight plan,
a delay caused by the prospective flight plan, and
additional wear to the second aircraft caused by the prospective flight plan.

20. The computer program product of claim 15, wherein the operation further comprises:
providing the improved flight plan to a flight plan arbiter for approval; and
receiving an approval to implement the improved flight plan at the second aircraft.
